(19) United States
(12) Patent Application Publication
(10) Pub. No.: US 2010/0073941 A1
(43) Pub. Date: Mar. 25, 2010

(54) High-power LED light base structure

(75) Inventor: Yen-Wei Ho, Taichung (TW)

Correspondence Address: GENIUS ELECTRONIC OPTICAL CO., LTD., P.O. BOX 215, TAICHUNG, 40099, TW

(73) Assignee: GENIUS ELECTRONIC OPTICAL CO., LTD.

(21) Appl. No.: 12/292,003

(22) Filed: Nov. 10, 2008

(30) Foreign Application Priority Data
Sep. 19, 2008 (TW) 097217018

(51) Int. Cl. F21V 21/00

(52) U.S. Cl. 362/368

(57) ABSTRACT

This invention proposes a high-power LED light base structure, which has a base plate, and at least one set of V-shape mounting module that comprises first and second slant faces for mounting LED purposes. And, there are upper and lower horizontal plates set between the first and second slant faces so as keep LED modules properly spaced. It is in such manner that the beams emitted from LED modules mounted in first and second slant faces interlace each other so as to have enhanced and uniform brightness.

### BACKGROUND OF THE INVENTION

Please refer to the FIG. 7 for prior art “High-power and high-efficiency LED lamp”. The prior art has a base body 160 that comprises multiple symmetrical mounting faces for purpose of mounting LED modules. The included angle (A) between the closest mounting face 1600 and the normal line 160 of the base body is 76°˜86°, the included angle (B) between the 2nd closest mounting face 1601 and the normal line 160 of the base body is 49°˜59°, and the included angle (C) between the 3rd closest mounting face 1602 and the normal line 160 of the base body is 37°˜47°. With aforementioned structure, the prior art aims to make the LED beam disperse so as to broaden the lighting range. However, such design makes the drawback of being too thick in dimension.

Another prior art “LED lamp structure” (as shown in FIG. 8) has a base body 100 that comprises a concaved mounting face 110 for purpose of mounting multiple LEDs 200 on it. Due to the concaved face, the mounted LEDs 200 face towards their center so as to have interlaced LED beam to broaden the lighting range. However, it also has same drawback as the abovementioned prior art.

With long time investments in researches and experiments, the inventor finally found an improved structure that can prevent aforementioned problems that prior arts encounter, and thus hereby proudly files application of patent to protect intellectual property.

### BRIEF SUMMARY OF THE INVENTION

This invention proposes a high-power LED light base structure. The light base has a base plate, and at least one set of V-shape (outward-V looking) mounting module that comprises first and second slant faces for mounting LED purposes. It is in such manner that the beams emitted from LEDs mounted in first and second slant faces interlace each other so as to have enhanced and uniform brightness.

One feature of this invention is that the included angle between the base plate and first slant face is same as that between the base plate and second slant face. As another design of course, that the included angle between the base plate and first slant face can be different from that between the base plate and second slant face.

Inside any V-shape mounting module, there is a horizontal plate (hereafter called upper plate) set between the first and second slant faces. And, there is also a horizontal plate (hereafter called lower plate) set between any two V-shape mounting modules. Both the upper and lower plates are facilitated to provide proper spaces between any two first and second slant faces so that LED beams can embrace higher uniformity and brightness.

### BRIEF DESCRIPTION OF THE DRAWINGS

FIG. 1—-A 3-D view of the preferred embodiment

FIG. 2—A side view of the preferred embodiment

FIG. 3—A bird view of the preferred embodiment

FIG. 4—A sectional view of the preferred embodiment before use

FIG. 5—A sectional view of the 2nd preferred embodiment

FIG. 6—A sectional view of the 2nd preferred embodiment before use

### DETAILED DESCRIPTION OF THE INVENTION

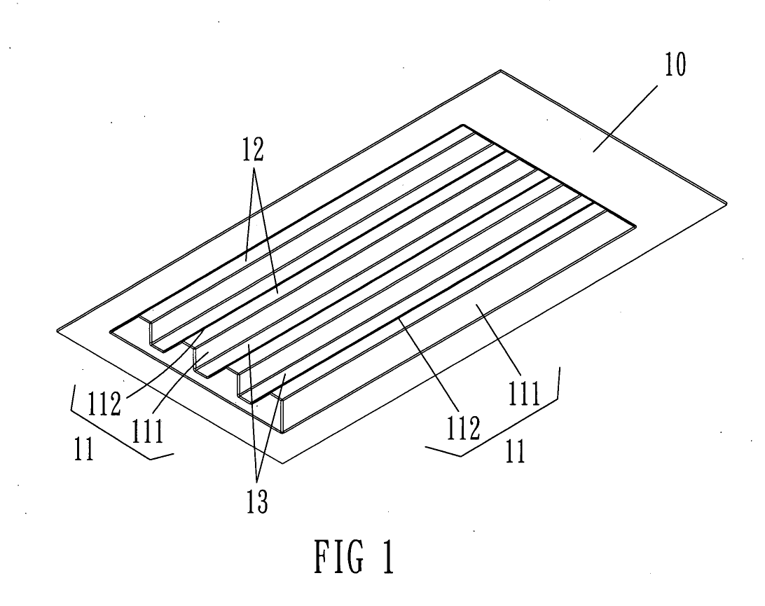

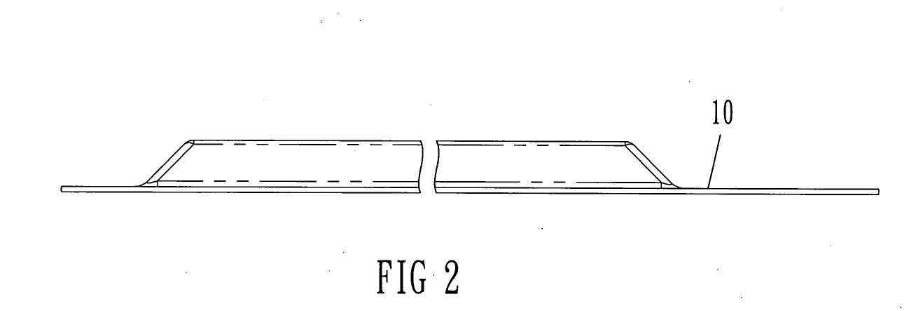

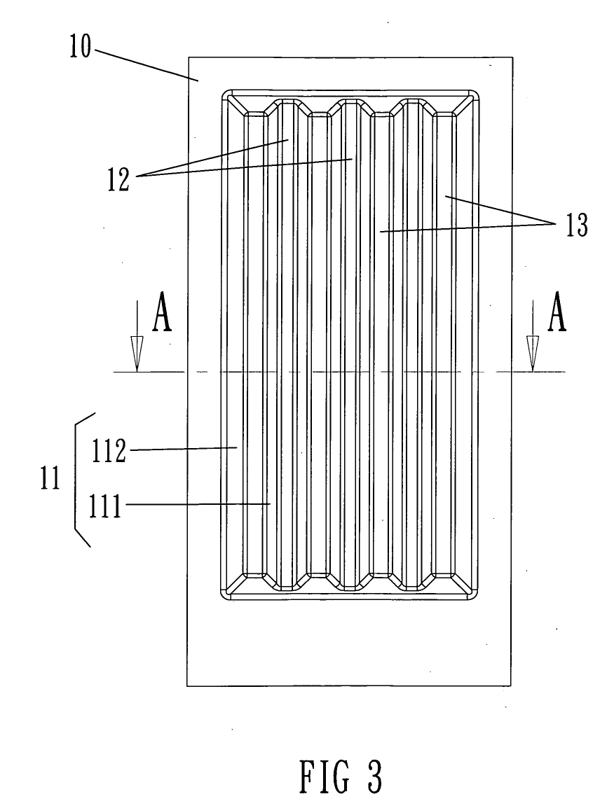

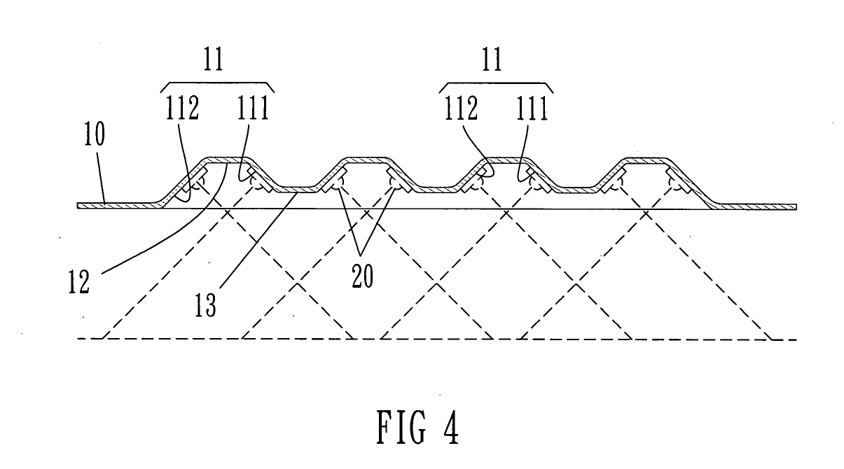

First, please refer to FIGS. 1-4 and following descriptions for the preferred embodiment for the invention of “A high-power LED light base structure” that comprises:
a base plate 10,
at least one V-shape mounting module 11 that further comprises rectangular first slant face 111, and second slant face 112 for mounting LED module 20. It is in such manner that the beams emitted from LED 20 mounted in first and second slant faces interlace each other so as to have enhanced and uniform brightness.

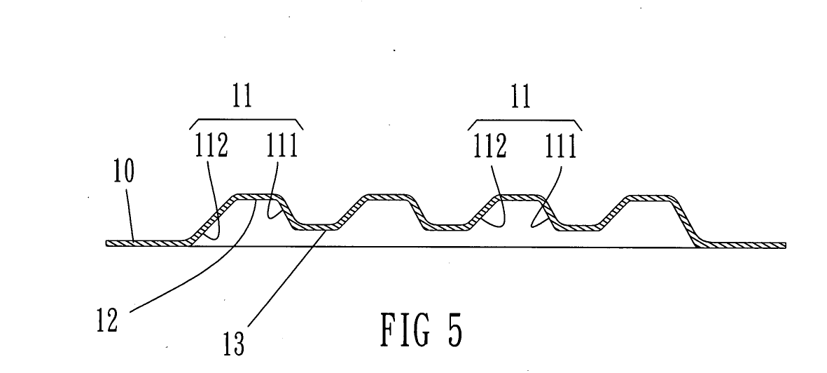

Moreover, the included angle between the base plate 10 and first slant face 111 is same as that between the base plate 10 and second slant face 112. As another design (shown in FIG. 5), the included angle between the base plate 10 and first slant face 111 can be different from that between the base plate 10 and second slant face 112.

Furthermore, inside any V-shape mounting module 11, there is a horizontal plate (hereafter called upper plate 12) set between the first and second slant faces 111, 112. And, there is also a horizontal plate (hereafter called lower plate 13) set between any two adjacent V-shape mounting modules 11. Both the upper and lower plates 11, 12 are facilitated to provide proper spaces between any two first and second slant faces 111, 112 so that LED beams can embrace higher uniformity and brightness.

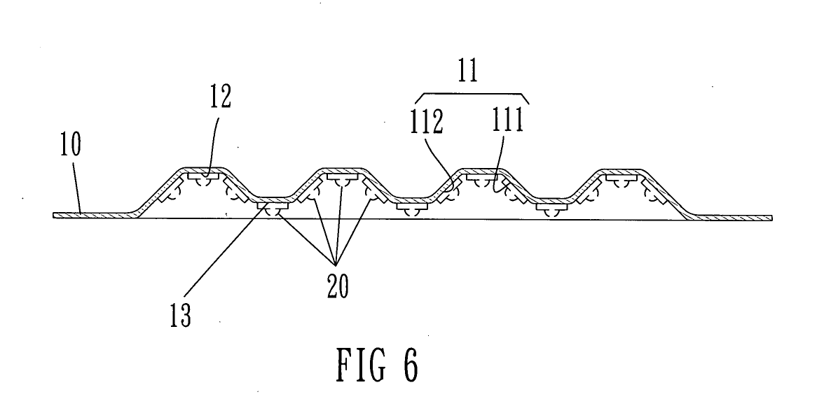

A shown in the FIG. 6, both the upper plate 12, and lower plate 13 can also mount with LED module 20. Together with the LED modules 20 mounted on the first and second slant faces 111, 112, the total brightness can be thus greatly enhanced.

With all aforementioned, the invention deserves grant of a patent based on its capability of industrial application and absolute novelty. The example illustrated above is just an exemplary embodiment for the invention, and shall not be utilized to confine the scope of the patent. Any equivalent modifications within the scope of claims of the patent shall be covered in the protection for this patent.

What is claimed is:

1. A high-power LED light base structure that comprises: a base plate; at least one set of V-shape mounting module that comprises rectangular first and second slant faces for mounting LED modules.

2. A high-power LED light base structure of claim 1, wherein the included angle between the said base plate and the said first slant face is same as that between the said base plate and the said second slant face.

3. A high-power LED light base structure of claim 1, wherein the included angle between the said base plate and the said first slant face is different from that between the said base plate and the said second slant face.

4. A high-power LED light base structure of claim 1, wherein there is an upper plate set between the said first and second slant faces of any said V-shape mounting modules.

5. A high-power LED light base structure of claim 1, wherein there is a lower plate set between any two said adjacent V-shape mounting modules.

6. A high-power LED light base structure of claim 4, wherein there the said upper plate mounts with LED module.

7. A high-power LED light base structure of claim 5, wherein the said lower plate mounts with LED module.
